(19) United States
(12) Patent Application Publication
(10) Pub. No.: US 2003/0021916 A1
(43) Pub. Date: Jan. 30, 2003

(54) Spatial decorative device for fixing to various objects

(76) Inventor: Yeong Shyan Hsueh, Chong Ho City (TW)

Correspondence Address: Yeong Shyan Hsueh, P.O. Box 10-69, Chong Ho, TW

(21) Appl. No.: 09/910,894

(22) Filed: Jul. 24, 2001

(51) Int. Cl. B44C 1/00

(52) U.S. Cl. 428/28; 428/19

(57) ABSTRACT

A spatial decorative device includes one or two base plates for securing together, or for attaching onto various kinds of objects, and each having one or more kinds of patterns applied on one or both surfaces. One or two cover panels may be secured onto the base plates and each may include one or more further patterns arranged corresponding to the patterns of the base plates for forming different patterns when viewing from different angles. The patterns may be dots, lines, star-shaped members, wavy lines, dotted lines, etc. The cover panel includes a reflective wavy outer surface.

### BACKGROUND OF THE INVENTION

1. Field of the Invention

The present invent ion relates to a spatial decorative device, and more particularly to a spatial decorative device for fixing or attaching onto various kinds of objects.

2. Description of the Prior Art

Typical objects, such as the pencil cases, frames for photos, suitcases, purses, notebooks, hand bags, key rings, etc., comprise an outer portion or an outer peripheral surface for applying with a planer pattern thereon. The objects may not be easily formed or applied with spatial or 3-D patterns thereon.

The present invention has arisen to mitigate and/or obviate the afore-described disadvantages of the conventional objects.

### SUMMARY OF THE INVENTION

The primary objective of the present invention is to provide a spatial decorative device for attaching onto various kinds of objects and for forming various kinds of spatial or 3-D patterns thereon.

In accordance with one aspect of the invention, there is provided a spatial decorative device includes one or two base plates for securing together, or for attaching onto various kinds of objects, and each having one or more kinds of patterns applied on one or both surfaces. One or two cover panels may be secured onto the base plates and each may include one or more further patterns arranged corresponding to the patterns of the base plates for forming different patterns when viewing from different angles.

The patterns may be dots, lines, star-shaped members, wavy lines, dotted lines, etc. The patterns of the base plates and the cover panels may be arranged close to each other, or aligned with each other, or offset from each other for forming various kinds of spatial or 3-D patterns. The cover panels each preferably includes a reflective wavy outer surface for reflecting purposes. The cover panels are further preferably made of transparent or semi-transparent materials.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a spatial decorative device in accordance with the present invention;

FIG. 2 is an exploded view of the spatial decorative device;

FIG. 3 is an exploded view showing some of the elements of the spatial decorative device, as seen from the opposite direction;

FIG. 4 is a cross sectional view taken along lines 4-4 of FIG. 1; and

FIGS. 5, 6, 7, 8, 9, 10, 11 are perspective views illustrating the operation of the spatial decorative device. or for illustrating the attachment of the spatial decorative device onto various kinds of objects.

### DETAILED DESCRIPTION OF THE PREFERRED EMBODIMENT

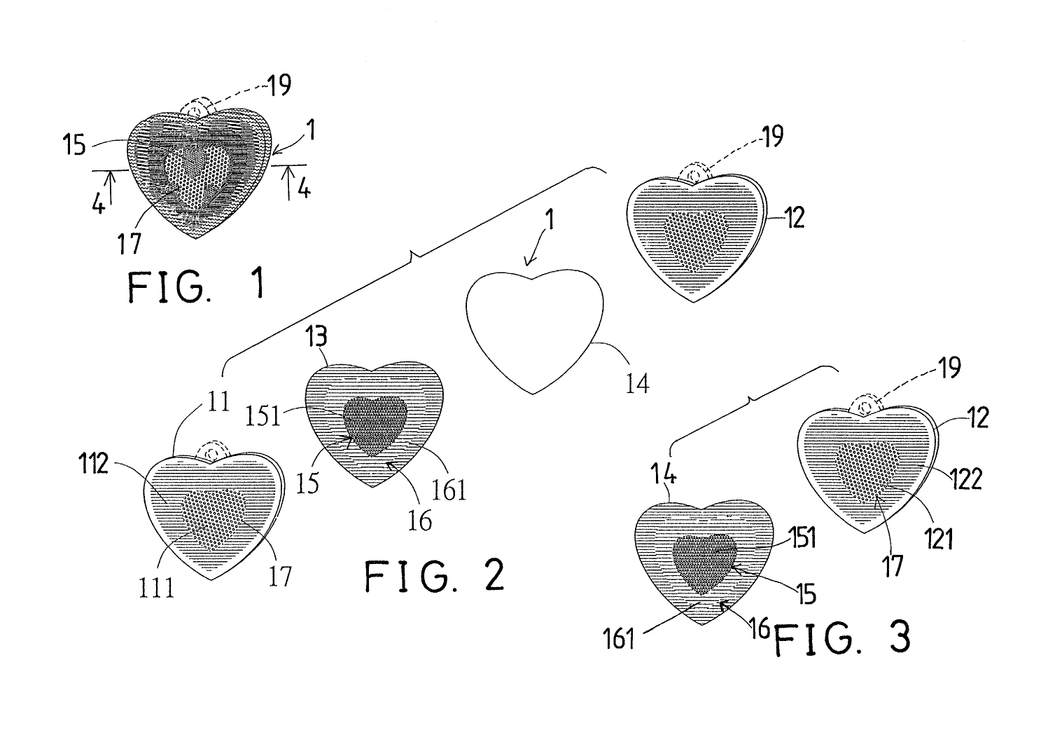

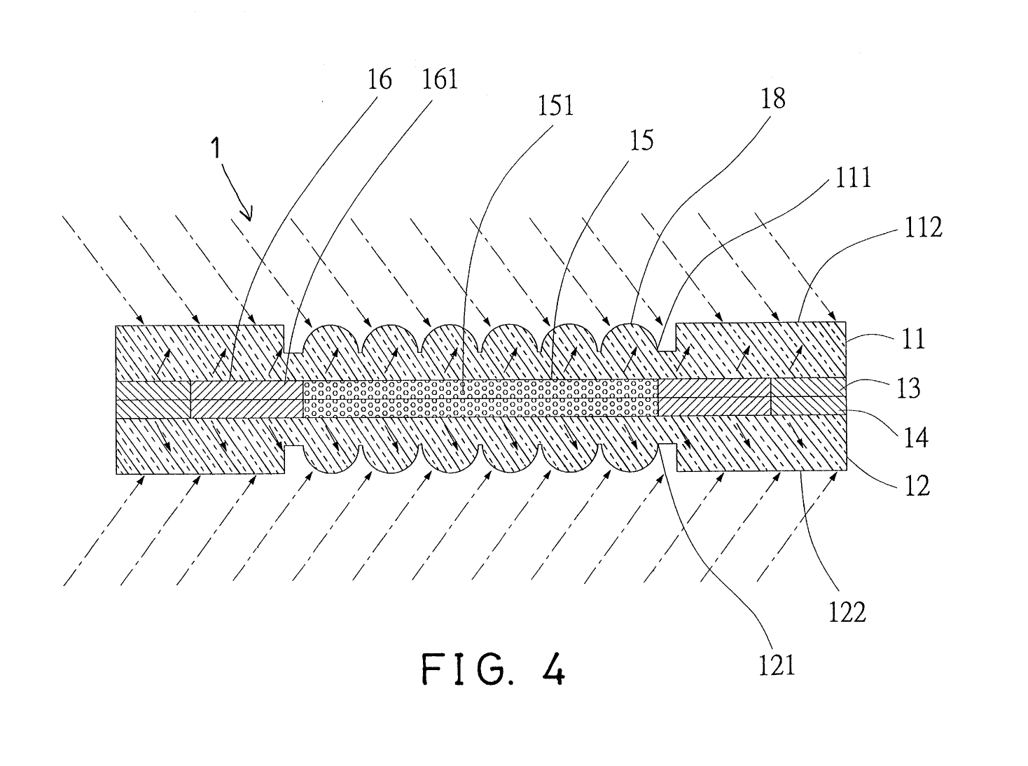

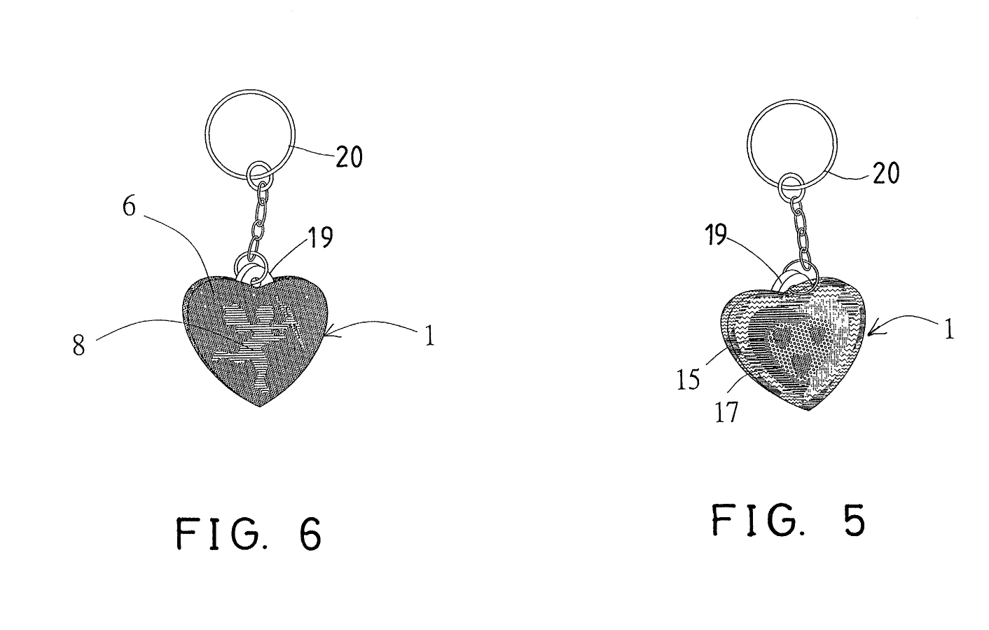

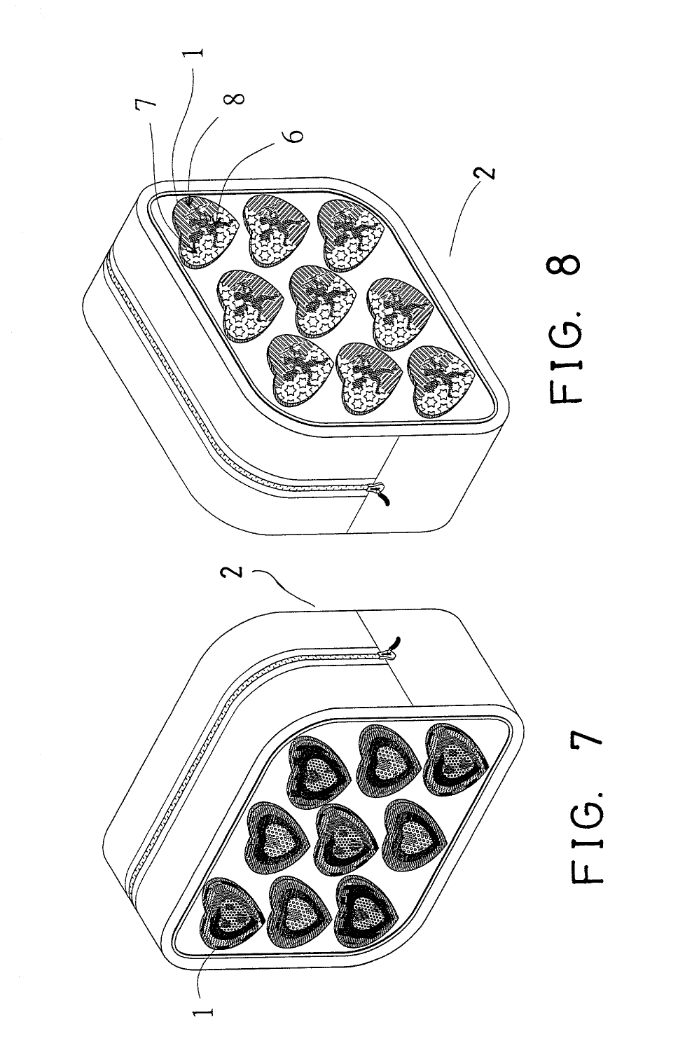

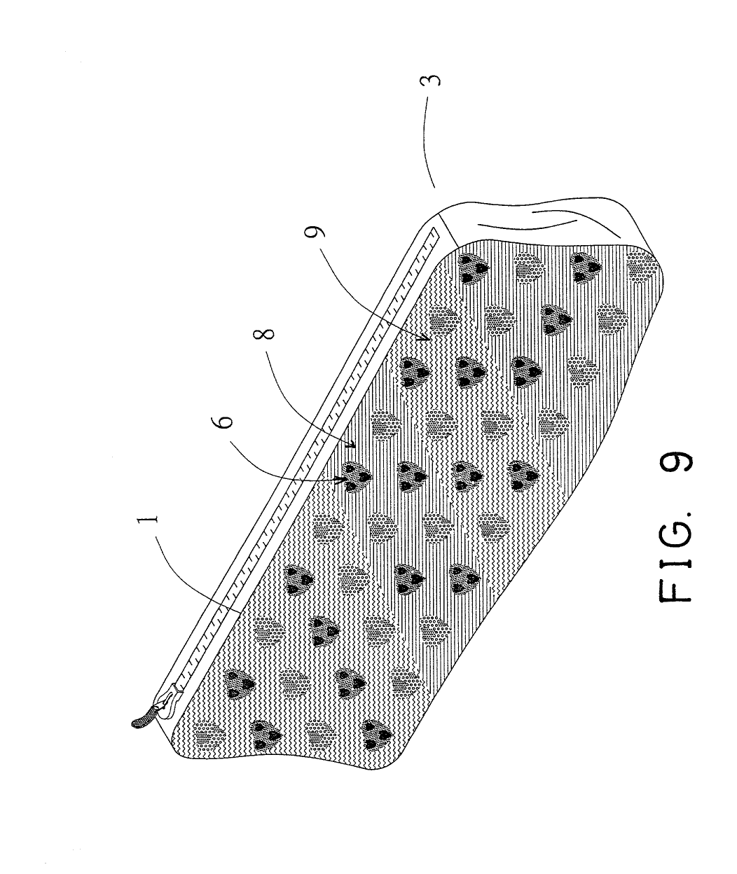

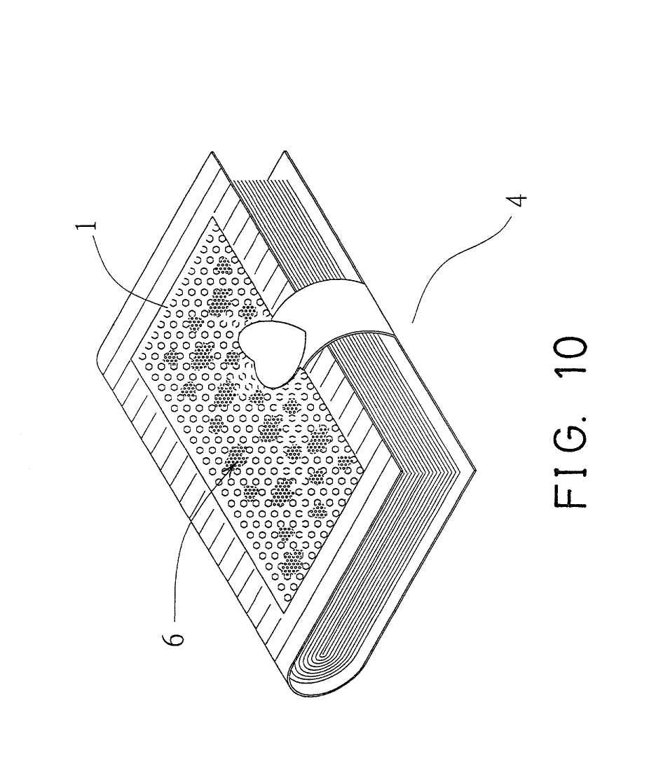

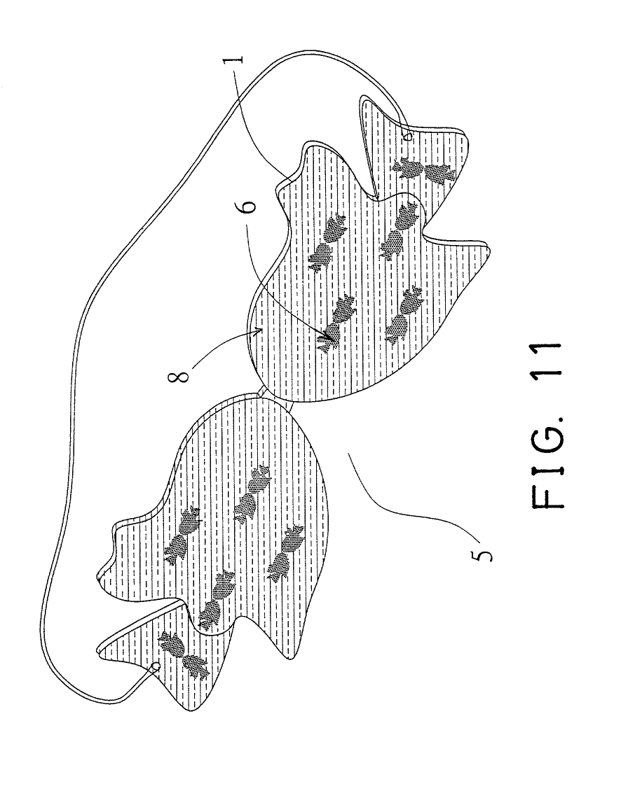

Referring to the drawings, and initially to FIGS. 1-4, a spatial decorative device in accordance with the present invention is generally designated with the reference numeral 1 and comprises one or two base plates 13, 14 for attaching onto various kinds of objects, such as for attaching or for forming as the key rings (FIGS. 5, 6), or for attaching onto the suitcases 2 (FIGS. 7, 8), or the purses 3 (FIG. 9), or the notebooks 4 (FIG. 10), or the other objects 5 (FIG. 11). The base plates 13, 14 may be secured together (FIG. 4), or may be secured onto the objects 2, 3, 4, 5 with the adhesive materials, the hook-and-loop fastening devices, or by the welding processes.

The base plates 13, 14 each includes one or more patterns 15, 16 formed or provided or applied thereon. For example, the base plates 13, 14 each includes a number of particles or dots 151 provided thereon, such as applied onto one or both the surfaces thereof, and arranged to form the pattern 15 thereon, and each may further include a number of lateral or longitudinal lines 161 arranged parallel to or perpendicular to each other for forming the other pattern(s) 16 thereon. The objects 2, 3, 4, 5 and/or the spatial decorative devices 1 may be applied with various kinds of patterns 6, 7, 8, 9 thereon (FIGS. 6-11). The spatial decorative devices 1 may also be applied with the other kinds of dots or lines or patterns thereon, such as the wavy lines in FIGS. 5, 9, the star-shaped patterns 7 in FIG. 8, or the dotted lines in FIG. 11, etc.

One or more cover panels 11, 12 may further be provided and attached or secured onto the base plates 13, 14 respectively, and are preferably made of transparent or semi-transparent materials for allowing the patterns 15, 16 on the base plates 13, 14 to be seen through the cover panels 11, 12. The cover panels 11, 12 may each include one or more patterns 17 formed or provided or applied thereon. For example, the cover panels 11, 12 each includes a number of particles or dots 111, 121 provided thereon and/or each includes a number of lateral or longitudinal lines 112, 122 arranged parallel to or perpendicular to each other for forming the pattern(s) 17 thereon.

The dots 111, 121, or the lines 112, 122, or the patterns 17 of the cover panels 11, 12 are arranged or disposed corresponding to, such as aligned with, or arranged close to, or offset from the dots 151, or the lines 161. or the patterns 15, 16 of the base plates 13, 14, for allowing the dots 111, 121, 151, and/or the lines 112, 122, 161, or the patterns 17, 15, 16 of the cover panels 11, 12 and the base plates 13, 14 to form various kinds of spatial or 3-D patterns when viewing the spatial decorative device 1 from different or various angles. The cover panels 11, 12 may each further include a wavy outer surface 18 (FIG. 4), for further reflecting the dots 111, 121, 151, and the lines 112, 122, 161, or the patterns 17, 15, 16 of the cover panels 11, 12 and the base plates 13, 14 to form the spatial or 3-D patterns.

In operation, as shown in FIGS. 7-11, the spatial decorative devices 1 may include a base plate 13 (or 14) and a cover panel 11 (or 12) secured together, and may have the base plate 13 attached or secured onto various kinds of objects 2, 3, 4, 5. As shown in FIGS. 1-6, the spatial decorative devices 1 may include two base plates 13, 14 secured together, and two cover panels 11, 12 secured onto the base plates 13, 14 respectively, and may include a loop or a hook or a ring 19 or the like for attaching with a key ring 20 (FIGS. 5, 6) or the like. The dots 111, 121, 151 may also be arranged close to or offset from the lines 112, 122, 161, or the other patterns 7, or the other lines or dots, such as the wavy lines, for forming the other spatial patterns.

Accordingly, the spatial decorative device in accordance with the present invention may be used for attaching onto various kinds of objects and for forming various kinds of spatial or 3-D patterns thereon.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A spatial decorative device comprising:
a base plate including a first pattern provided thereon, and
a cover panel secured onto said base plate and including a second pattern provided thereon and arranged corresponding to said first pattern of said base plate for forming different patterns when viewing said spatial decorative device from different angles.

2. The spatial decorative device according to claim 1, wherein said first pattern includes a number of dots.

3. The spatial decorative device according to claim 1, wherein said first pattern includes a number lines.

4. The spatial decorative device according to claim 1, wherein said first pattern includes a number of star-shaped members provided therein.

5. The spatial decorative device according to claim 1, wherein said first pattern includes a number of wavy lines.

6. The spatial decorative device according to claim 1, wherein said second pattern includes a number of dots.

7. The spatial decorative device according to claim 1, wherein said second pattern includes a number of lines.

8. The spatial decorative device according to claim 1, wherein said second pattern includes a number of star-shaped members provided therein.

9. The spatial decorative device according to claim 1, wherein said second pattern includes a number of wavy lines.

10. The spatial decorative device according to claim 1, wherein said cover panel includes a wavy outer surface for reflective purposes.

11. A spatial decorative device comprising:
a first base plate including a first pattern provided thereon, and
a second base plate secured onto said first base plate, and including a second pattern provided thereon and arranged corresponding to said first pattern of said first base plate for forming different patterns when viewing said spatial decorative device from different angles.

12. The spatial decorative device according to claim 11, wherein said first pattern includes a number of dots.

13. The spatial decorative device according to claim 11, wherein said first pattern includes a number of lines.

14. The spatial decorative device according to claim 11, wherein said second pattern includes a number of dots.

15. The spatial decorative device according to claim 11, wherein said second pattern includes a number of lines.

16. The spatial decorative device according to claim 11 further comprising a cover panel secured onto said first base plate.

17. The spatial decorative device according to claim 16, wherein said cover panel includes a wavy outer surface for reflective purposes.

18. The spatial decorative device according to claim 11 further comprising a cover panel secured onto said second base plate.

19. The spatial decorative device according to claim 18, wherein said cover panel includes a wavy outer surface for reflective purposes.
